(19) United States
(12) Patent Application Publication
(10) Pub. No.: US 2012/0202163 A1
(43) Pub. Date: Aug. 9, 2012

(54) Orthodontic bracket

(76) Inventor: Nikhil Shankarlal Vashi, Mumbai (IN)

(21) Appl. No.: 13/068,085

(22) Filed: May 2, 2011

(30) Foreign Application Priority Data
Feb. 9, 2011 (IN) 369/MUM/2011

(51) Int. Cl. A61C 7/14

(52) U.S. Cl. 433/8

(57) ABSTRACT

An orthodontic bracket includes a body contoured to fit a tooth surface and a lumen extending horizontally across the body to engage orthodontic wires. Different embodiments of the orthodontic bracket are disclosed herein.

### TECHNICAL FIELD

The disclosure herein relates generally to orthodontic brackets.

### BACKGROUND

Orthodontic brackets are used with arch wires to straighten irregular teeth. The brackets are attached to the teeth, and engage a flexible arch wire that exerts pressure upon them to move the teeth. The most commonly used brackets are edgewise brackets as shown in FIGS. 1, and 2. FIG. 1 shows a Siamese twin bracket, and FIG. 2 shows a single bracket with rotation wings. Such brackets typically include an arch wire slot that extends horizontally across the face of the bracket for the reception of the arch wire. The arch wire slot can be angularly oriented to minimize bending of arch wires. A pair of wings extend vertically on either side of the arch wire slot from the bracket enabling ligature means to be tied to the bracket to retain the arch wire in the slot. Stainless steel ligature ties or elastomeric ligature rings are conventionally used as the ligature means. FIG. 3 shows a self-locking orthodontic bracket. Such brackets have sliding covers or spring clips to retain the arch wire in the slot. FIG. 4 shows a thin metal bracket with a lumen extending across the body. This is made from a thin sheet of metal folded over itself. FIG. 5 shows the thin bracket attached on to the surface of a tooth. This bracket cannot be used with aesthetic, tooth-coloured or transparent orthodontic brackets as it is more visible.

Regular orthodontic brackets are thick and wide. When teeth are crowded or rotated, the surfaces on which the brackets are fixed are not exposed enough to place the brackets in their proper positions. In deep bite conditions where the upper teeth overlap the lower teeth substantially, fixing brackets on the lower teeth interfere in biting and the patient would be uncomfortable. It may also cause dislodgment of the bracket. The regular brackets cannot be placed on teeth that are narrow or partially erupted. When the regular brackets are fixed on the teeth that are projecting out of the dental arch, they irritate the soft tissues of the lips and cheeks causing ulcerations.

### SUMMARY

In accordance with the principles herein, a thin orthodontic bracket is set forth. The bracket can be fixed on irregular teeth to get them in proper alignment. The bracket is very easy to manufacture and use. The bracket can be used in different conditions like crowding and rotations of teeth, deep bite, small teeth, impacted teeth, irregular second molars etc. where it is difficult to fix regular brackets. The bracket is less visible and more aesthetic when made with tooth coloured or transparent materials. The bracket is more attractive when made with different colours and shapes.

A bracket constructed in accordance with the principles herein is very simple. In general, the bracket includes a body that is contoured to fit a tooth surface. A lumen extends horizontally across the width of the body. The lumen is used for passing a ligature wire to tie an arch wire that exerts pressure on to the tooth. It can also be used for passing an arch wire through it instead of tying it.

Although various different embodiments of the bracket and the lumen are described, the bracket essentially works in the same manner to secure an arch wire.

The objects and advantages of the bracket herein will become apparent from a consideration of the drawings and ensuing description.

### BRIEF DESCRIPTION OF THE DRAWINGS

FIG. 1 is a perspective view of a typical prior art bracket known as Siamese twin edgewise bracket.

FIG. 2 is a perspective view of a typical prior art bracket showing a single edgewise bracket with rotation wings.

FIG. 3 is a perspective view of a prior art self-locking bracket.

FIG. 4 is a perspective view of a prior art thin orthodontic bracket made from metal sheet.

FIG. 5 is a side view of the prior art thin orthodontic bracket attached to a tooth.

FIG. 6A is a perspective view of one embodiment of an orthodontic bracket according to the principles herein having a body and a lumen extending horizontally across the body at one end.

FIG. 6B is a side view of the bracket of FIG. 6A.

FIG. 7A is a perspective view of another embodiment of an orthodontic bracket according to the principles herein showing a metal insert with a lumen extending horizontally in a body.

FIG. 7B is a side view of the bracket of FIG. 7A.

FIGS. 8A, B, C AND D are top views of different embodiments of the metal inserts of the bracket of FIGS. 7A and B.

FIG. 9A is a perspective view of another embodiment of an orthodontic bracket according to the principles herein showing a metal insert forming a horizontally extending lumen with a body.

FIG. 9B is a side view of the bracket of FIG. 9A.

FIG. 10A is a perspective view of another embodiment of an orthodontic bracket according to the principles herein showing a rectangular lumen extending horizontally across a body.

FIG. 10B is a side view of the bracket of FIG. 10A.

FIG. 11A is a perspective view of another embodiment of an orthodontic bracket according to the principles herein showing a rectangular lumen extending horizontally across a body in a different orientation.

FIG. 11B is a side view of the bracket of FIG. 11A.

FIG. 12A is a perspective view of another embodiment of an orthodontic bracket according to the principles herein showing a round lumen extending horizontally in the middle of the body.

FIG. 12B is a side view of the bracket of FIG. 12A.

FIG. 13A is a perspective view of another embodiment of an orthodontic bracket according to the principles herein showing a rectangular lumen extending horizontally in the middle of the body.

FIG. 13B is a side view of the bracket of FIG. 13A.

FIG. 14A is a perspective view of another embodiment of an orthodontic bracket according to the principles herein having a body and two lumens extending horizontally across the body.

FIG. 14B is a side view of the bracket of FIG. 14A.

FIG. 15A is a perspective view of another embodiment of an orthodontic bracket according to the principles herein having a body and two rectangular lumens extending horizontally across the body.

FIG. 15B is a side view of the bracket of FIG. 15A.

FIG. 16A is a perspective view of another embodiment of an orthodontic bracket according to the principles herein having a body and two lumens extending horizontally across the body made by folding a metal sheet.

FIG. 16B is a side view of the bracket of FIG. 16A.

FIG. 17A is a perspective view of another embodiment of an orthodontic bracket according to the principles herein showing a lumen extending vertically across the middle of the body.

FIG. 17B is a side view of the bracket of FIG. 17A.

FIG. 18A is a perspective view of another embodiment of an orthodontic bracket according to the principles herein showing a lumen extending vertically across the middle of the body formed by folding a metal sheet.

FIG. 18B is a side view of the bracket of FIG. 18A.

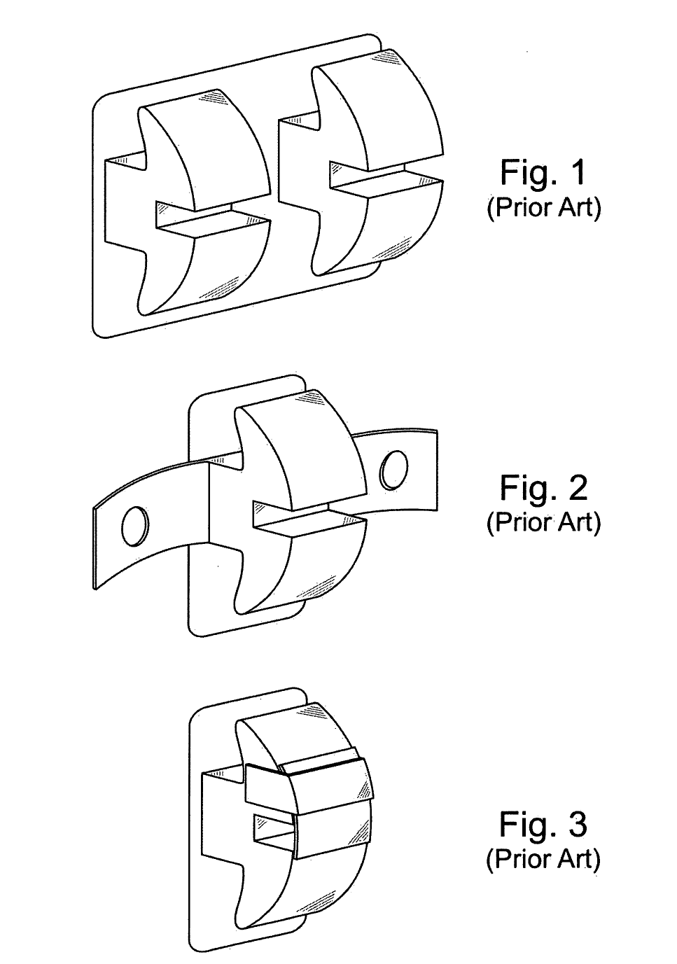

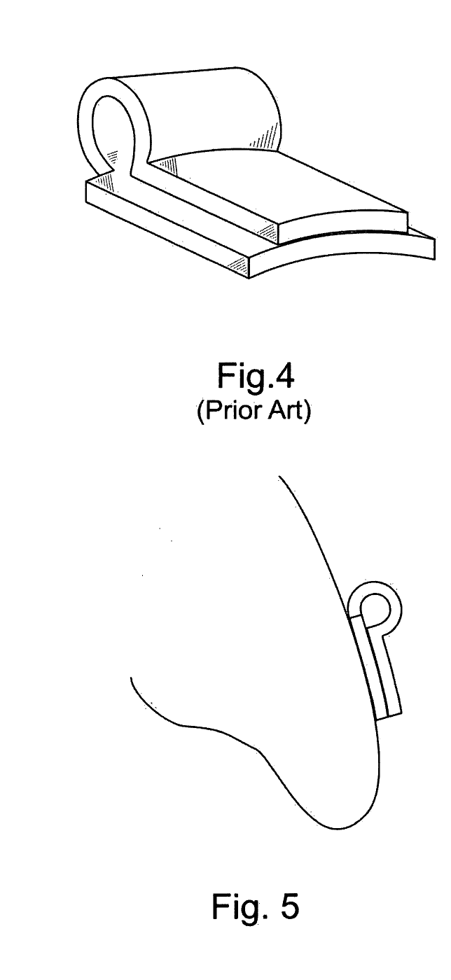

### DETAILED DESCRIPTION

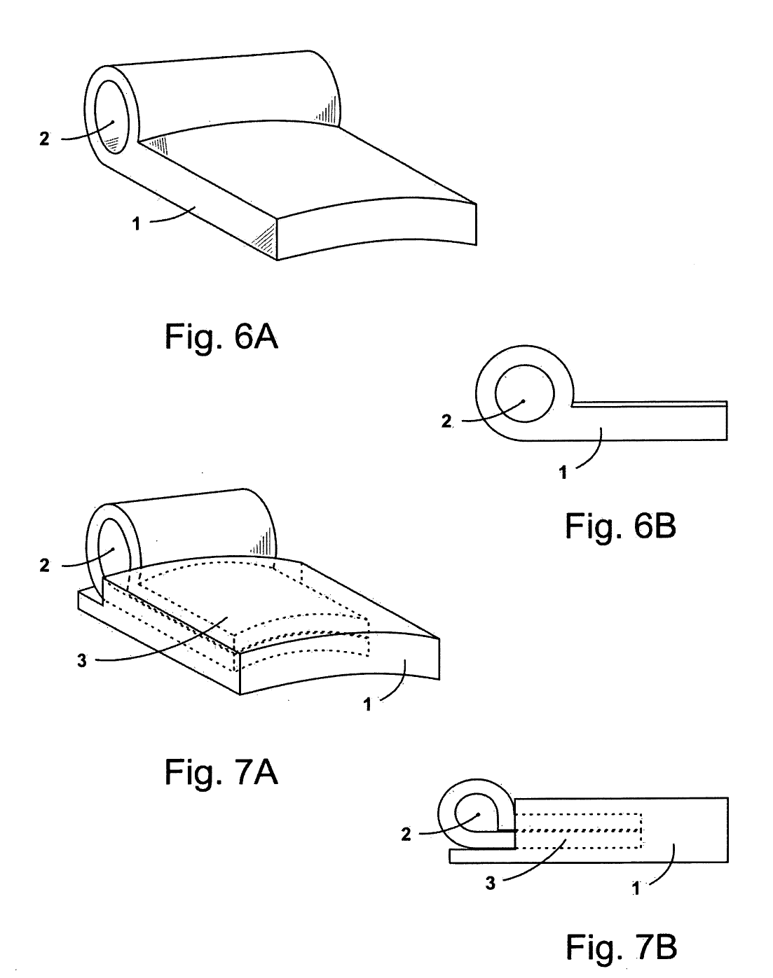

The following describes exemplary embodiments constructed in accordance with the principles herein as illustrated in FIGS. 6A to 18B.

FIGS. 6A and 6B show an orthodontic bracket constructed in accordance with the principles herein. The bracket includes a body 1 that is contoured to fit a tooth surface and can be bonded directly to a tooth. The body 1 of the bracket can be of metal, plastic, composite resin, polycarbonate, and ceramic or of any other permissible material. The body 1 may be of any colour. The body 1 of the bracket has a lumen 2 extending horizontally across to pass an arch wire or a ligature wire during orthodontic treatment to exert pressure.

FIGS. 7A and 7B show another embodiment constructed in accordance with the principles herein wherein an insert 3 made by folding a metal sheet over itself, keeping a small lumen 2 is embedded within the body 1 of the bracket. The body 1 of the bracket can be of plastic, composite resin, polycarbonate, and ceramic or of any other permissible material. The lumen 2 is kept out of the body 1 of the bracket at one end. The metal insert 3 gives strength to the lumen 2 to withstand chewing forces.

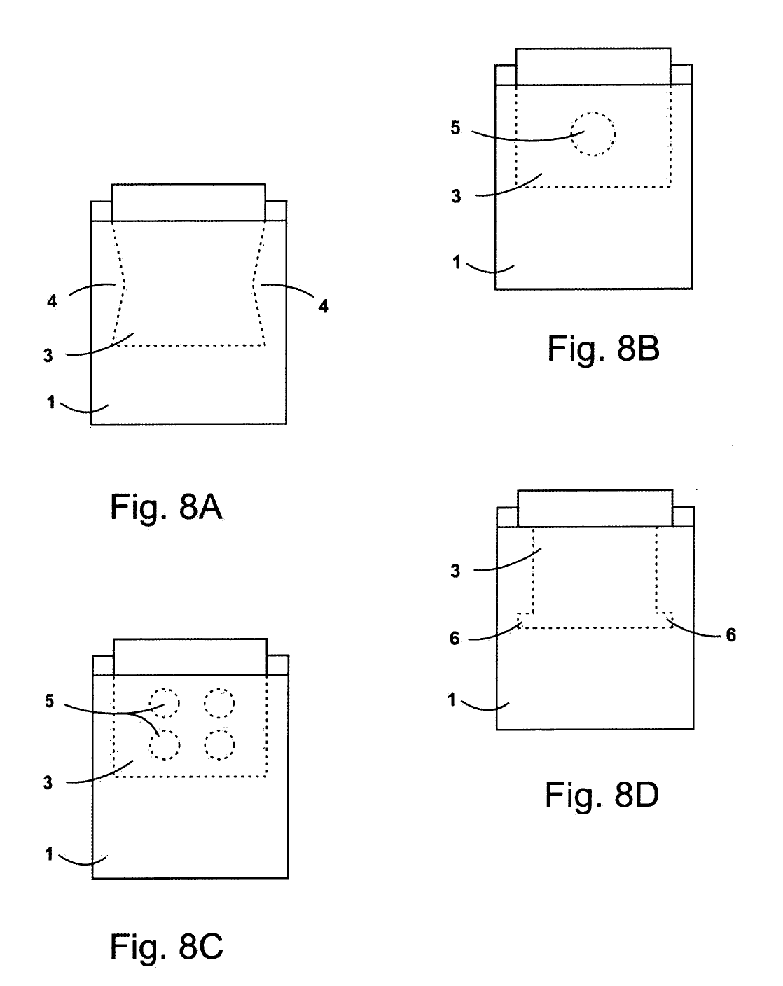

FIGS. 8A, B, C and D show different embodiments of the metal insert 3 that can be placed in the body 1 of a bracket constructed in accordance with the principles herein. FIG. 8A shows notches 4 on the sides of insert 3 to prevent it from sliding out of body 1.

FIG. 8B shows a hole 5 in metal insert 3 to prevent it from sliding out of body 1.

FIG. 8C shows a number of holes 5 in the metal insert.

FIG. 8D shows projections 6 at the end of metal insert 5 to prevent it from sliding out of body 1.

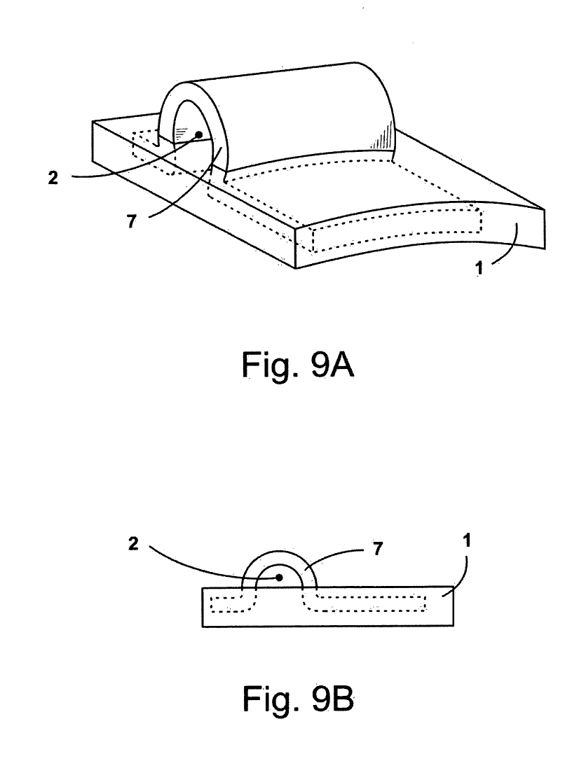

FIGS. 9A and 9B show another embodiment constructed in accordance with the principles herein wherein a metal sheet 7 is bent to form a lumen 2 with body 1.

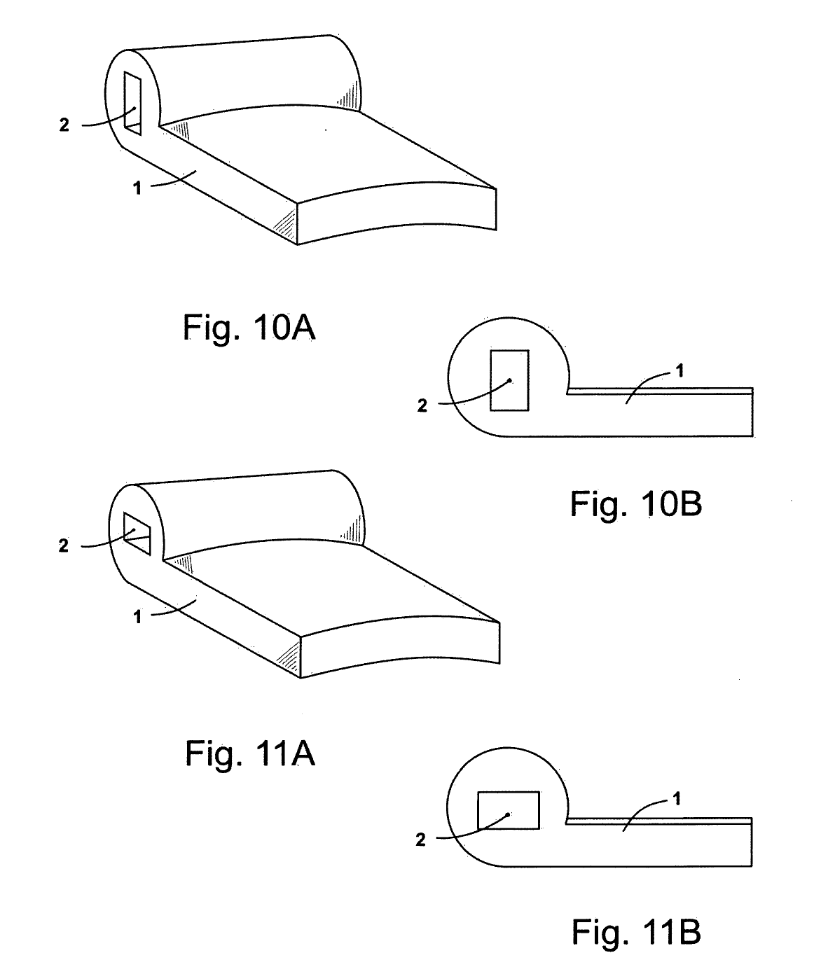

FIGS. 10A and 10B show another embodiment constructed in accordance with the principles herein wherein body 1 has rectangular lumen 2 to engage square and rectangular arch wires.

FIGS. 11A and 11B show another embodiment constructed in accordance with the principles herein wherein body 1 has rectangular lumen 2 in a different orientation to provide built-in torque when used with a rectangular wire.

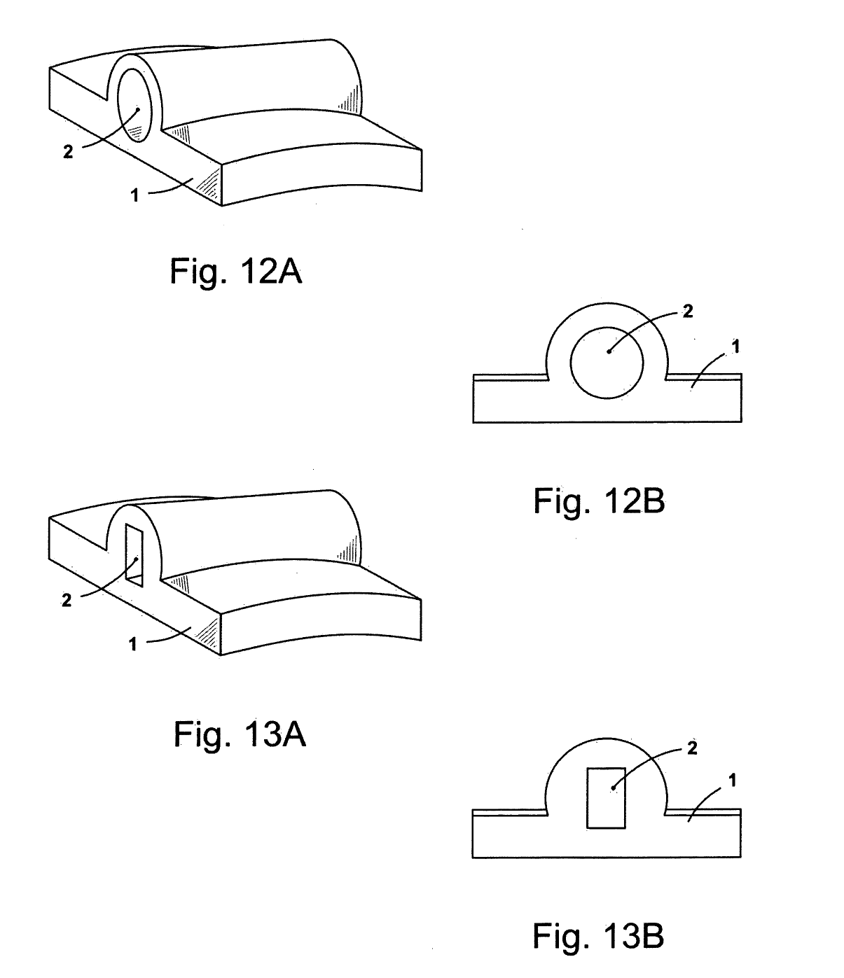

FIGS. 12A and 12B show another embodiment constructed in accordance with the principles herein wherein lumen 2 is placed away from the edge of body 1.

FIGS. 13A and 13B show another embodiment constructed in accordance with the principles herein wherein lumen 2 is rectangular and is placed away from the edge of body 1.

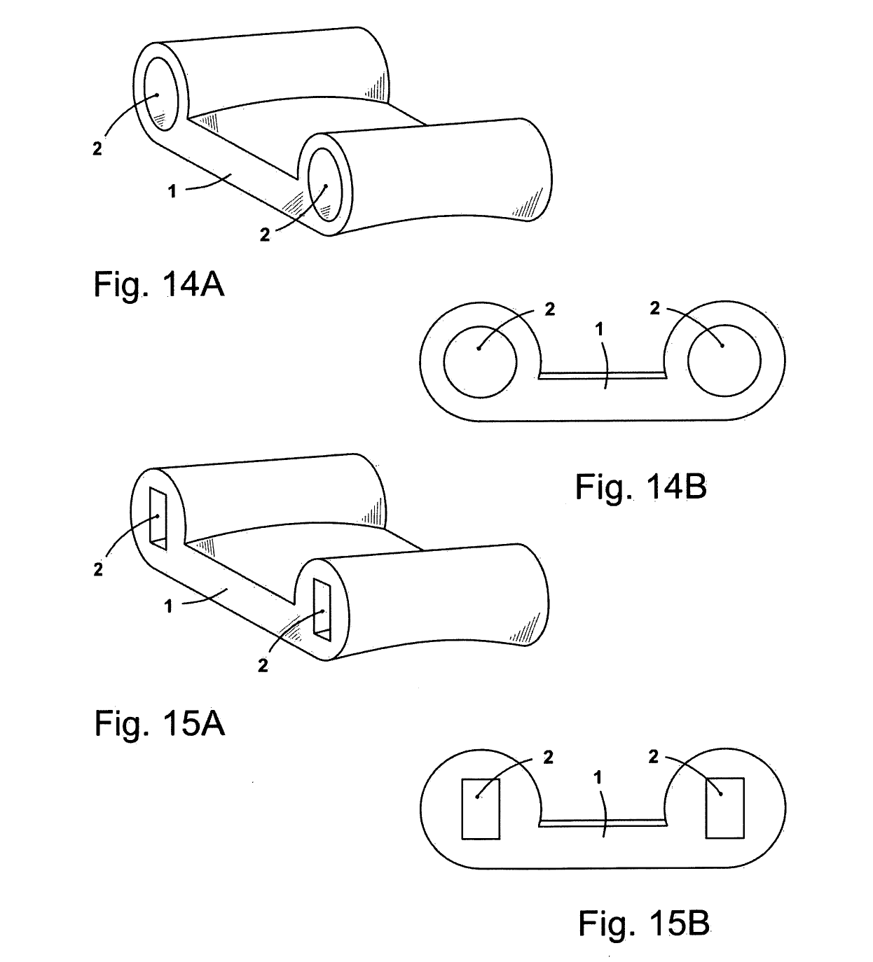

FIGS. 14A and 14B show another embodiment constructed in accordance with the principles herein wherein two lumens 2 run horizontally across body 1.

FIGS. 15A and 15B show another embodiment constructed in accordance with the principles herein wherein two rectangular lumens 2 run horizontally across body 1 to engage rectangular arch wires.

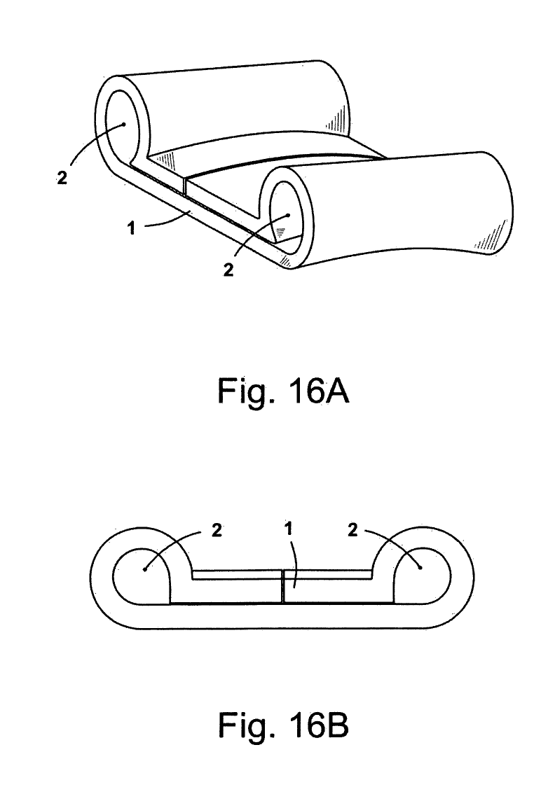

FIGS. 16A and 16B show another embodiment constructed in accordance with the principles herein wherein body 1 is made of a metal sheet and two lumens 2 made by folding the metal sheet extend horizontally across the body 1.

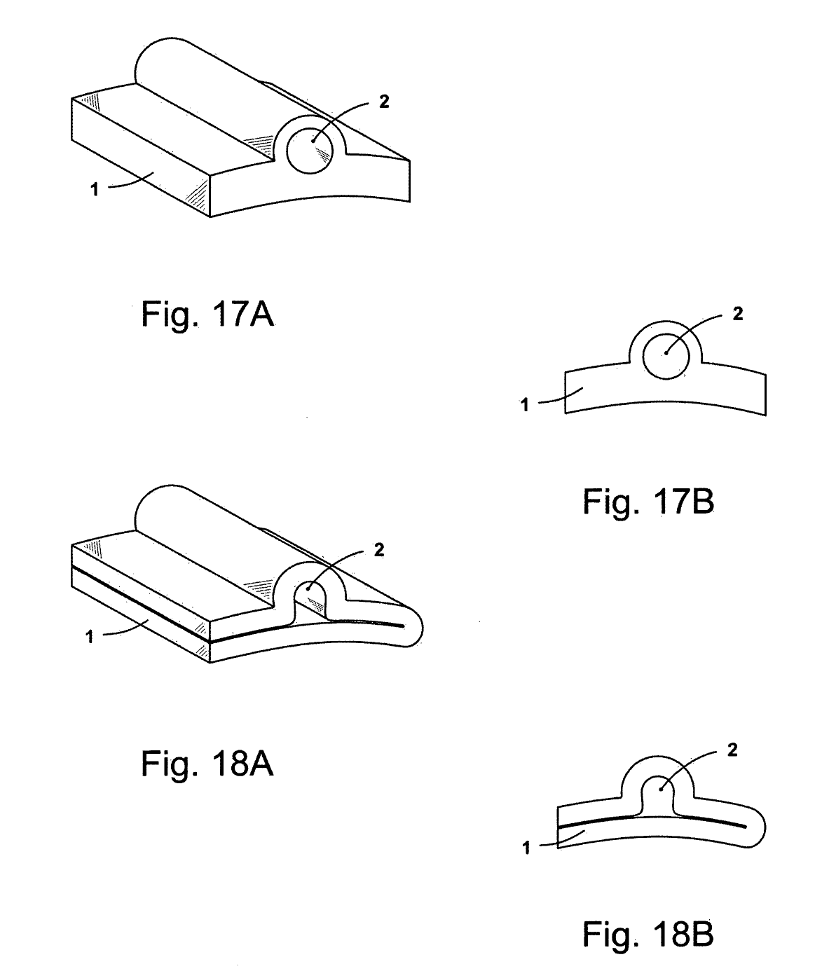

FIGS. 17A and 17B show another embodiment constructed in accordance with the principles herein wherein lumen 2 extends vertically across body 1 to pass a ligature wire during orthodontic treatment to exert pressure.

FIGS. 18A and 18B show another embodiment constructed in accordance with the principles herein wherein body 1 is made of a metal sheet and a lumen 2 made by folding the metal sheet extends vertically across the body 1 to pass a ligature wire during orthodontic treatment to exert pressure.

Although the description above contains many specificities, these should not be construed as limiting the scope of the disclosure but as merely providing illustrations of some of the presently preferred exemplary embodiments constructed in accordance with the principles herein. For example, the bracket can have various shapes like round, square, oval, triangular, rhomboid, trapezoid, star, heart, irregular etc. The different features of the metal insert like holes, notches, projections, etc. can be combined with the different embodiments of the bracket illustrated in the description.

The embodiments constructed in accordance with the principles herein can have hooks added to the bracket for engaging elastics. The lumens of different embodiments described here can extend across the body in any angle horizontally or vertically. The rectangular lumens of different embodiments described here can also have built-in force vectors (e.g., torque, and tip). The different embodiments described here can be attached to the labial as well as the lingual surfaces of teeth. Although the edges of the bracket are sharp in the drawings, they would be smoothened in the manufactured brackets to make them comfortable to the patients.

What is claimed is:

1. An orthodontic bracket comprising:
a body contoured to fit a tooth surface and said body having a mesially-distally extending lumen for receiving an orthodontic wire.

2. The orthodontic bracket defined in claim 1, wherein said body is made of a material selected from the group consisting of metal, plastic, composite resins, ceramic, polycarbonate, and fibreglass.

3. The orthodontic bracket defined in claim 1, wherein said body has different colours.

4. The orthodontic bracket defined in claim 1, wherein the shape of said body is selected from the group consisting of circle, oval, square, rectangular, triangular, trapezoid, rhomboid, star, heart, and irregular shape.

5. The orthodontic bracket defined in claim 1, wherein the shape of said lumen is selected from the group consisting of circle, oval, square, rectangular, triangular, trapezoid, rhomboid, and irregular shape.

6. An orthodontic bracket comprising:
a body contoured to fit a tooth surface, said body including an insert made from a metal sheet having a mesially-distally extending lumen, formed by folding the sheet over itself, for receiving an orthodontic wire.

7. The orthodontic bracket defined in claim 6, wherein said body is made of a colourful material selected from the group consisting of materials such as plastic, composite resins, ceramic, polycarbonate, and fibreglass.

8. The orthodontic bracket defined in claim 6, wherein the shape of said body is selected from the group consisting of circle, oval, square, rectangular, triangular, trapezoid, rhomboid, star, heart, and irregular shape.

9. The orthodontic bracket defined in claim 6, wherein said insert has a notch on either side to prevent it from sliding out.

10. The orthodontic bracket defined in claim 6, wherein said insert has at least one hole to prevent it from sliding out.

11. The orthodontic bracket defined claim 6, wherein said insert has projections on either side at the end to prevent it from sliding out.

12. An orthodontic bracket comprising:
a body contoured to fit a tooth surface, said body having an insert made from a metal sheet bent to make a mesially-distally extending lumen with said body, for receiving an orthodontic wire.

13. The orthodontic bracket defined in claim 12, wherein said body is made of a colourful material selected from the group consisting of plastic, composite resins, ceramic, polycarbonate, and fibreglass.

14. The orthodontic bracket defined in claim 12, wherein the shape of said body is selected from the group consisting of circle, oval, square, rectangular, triangular, trapezoid, rhomboid, star, heart, and irregular shape.

15. An orthodontic bracket comprising:
a body contoured to fit a tooth surface, said body having two mesially-distally extending lumens for receiving an orthodontic wire.

16. The orthodontic bracket defined in claim 15, wherein said body is made of a material selected from the group consisting of metal, plastic, composite resins, ceramic, polycarbonate, and fibreglass.

17. The orthodontic bracket defined in claim 15, wherein said lumens are selected from the group consisting of circle, oval, square, rectangular, triangular, trapezoid, rhomboid, and irregular shape.

18. An orthodontic bracket comprising:
a body contoured to fit a tooth surface and said body having a gingivally-occlusally extending lumen for receiving an orthodontic wire.

19. The orthodontic bracket defined in claim 18, wherein said body is made of a material selected from the group consisting of metal, plastic, composite resins, ceramic, polycarbonate, and fibreglass.
